(19) United States
(12) Patent Application Publication
(10) Pub. No.: US 2010/0054871 A1
(43) Pub. Date: Mar. 4, 2010

(54) TOOL

(75) Inventor: Leo Prakash, Rottenburg (DE)

Correspondence Address: CONNOLLY BOVE LODGE & HUTZ, LLP, P O BOX 2207, WILMINGTON, DE, 19899, US

(73) Assignee: H.C. Starch GmbH, Goslar (DE)

(21) Appl. No.: 12/595,752

(22) PCT Filed: Apr. 7, 2008
(86) PCT No.: PCT/EP2008/054124

§ 371 Date: Nov. 19, 2009

(30) Foreign Application Priority Data
Apr. 11, 2007 (DE) 10 2007 017 306.9

(51) Int. Cl. B23B 27/14; B23C 5/16; B23C 5/28; B23B 27/10

(52) U.S. Cl. 407/11; 407/119; 408/1 R; 408/144

(57) ABSTRACT

The invention relates to a hard metal tool which rotates about its own longitudinal axis, has an l/d ratio of 2 to 200 and is intended for the drilling or milling of materials. The hard metal tool contains a hard material phase and a binder phase, wherein the main binder constituents are iron, nickel and cobalt, the iron content is between 50 and 90% by weight, the nickel content is between 10 and 30% by weight, the cobalt content is at most 30% by weight and the cobalt to nickel Co:Ni ratio is less than or equal to 1, based on % by weight.

### TECHNICAL FIELD

The invention relates to hard metal tools which are suitable for the drilling or milling of materials.

### PRIOR ART

This involves tool geometries which are characterized in that the tool consisting of hard metal has a longitudinal axis, which is simultaneously the axis of rotation during the machining of the material, and a cross section which is perpendicular to said longitudinal axis and is enveloped by a circle. The tool diameter d (corresponds to the diameter of the enveloping circle) is smaller than the length of the tool by the ratio l/d, where l is the length of the axis of rotation. During drilling, the tool which rotates about the longitudinal axis is pressed against the material to be drilled. The cutting edge at the end of the tool produces chips which, as soon as the drill hole has reached a certain depth, are removed via one or more helical or linear channels located in the cylinder surface of the tool. The l/d ratio may be between 5 and 20; however, in the case of miniature drills for machining printed circuit boards for the electronics industry, this ratio by all means reaches the factor of 200. In the case of milling, the tool is additionally designed in such a way that it is provided both with channels at the end and with channels which have a cutting effect laterally in the cylinder surface; the chip-conveying channel can be entirely or partially omitted.

In the case of drilling, the cross section of the tool must be able to transmit a certain torque composed of the cutting forces and the conveying forces of the chips in the channel. Peak loads occur if chips become jammed. The channel(s) represent(s) a reduction in the cross-sectional area that is able to bear a load, and is/are possible starting points for the catastrophic growth of cracks, which results in the tool rupturing.

The continuous trend for miniaturization produces a quadrate decrease in the transmittable torque together with a decrease in the tool diameter, while the cutting forces fall only linearly. The machining reliability is reduced since the tool is increasingly likely to rupture. This affects particularly tools for drilling and milling printed circuit boards for the electronics industry, as well as deep-hole drills.

Milling produces not only the loads described for drilling but also lateral forces, i.e. forces which act perpendicularly with respect to the axis of rotation. The premature or incalculable rupturing of the tool, before it has reached the wear limit, causes economic damage in the form of scrap and unplanned breakdown and change-over times.

The maximum tool forces to be transmitted depend on the properties of the hard metal material and may be determined by generally familiar mechanical characteristic values such as bending rupture strength or fracture toughness (K_{1C}). In the hard metal industry, the fracture toughness is usually calculated from the crack lengths of the Vickers hardness indentation, the hardness and the load according to Shetty's formula. Whereas the bending rupture strength describes a real body that contains defects which trigger fracture, the K_{1C} value characterizes the fracture toughness of the material per se and therefore the strength potential of a material when it is completely free from defects, and is therefore better suited for systematic comparisons of materials regardless of the quality of the microstructure. There is an approximately positive correlation between the wear resistance of a tool and the hardness. However, it is only possible to improve hardness and strength at the cost of the other property in each case. By way of example, it would therefore be desirable, for the tools described, to increase the strength without a loss in hardness or to increase the hardness without a loss in strength.

The superior properties of hard metals, i.e. composite materials of metals from the iron group as binder (“binder phase”) and hard materials (carbides, nitrides, “hard material phase”), mean that these have gained acceptance over other classes of material as materials for machining metals, stones and composite materials, for example, organically/inorganically. The high hardness and wear resistance of tungsten carbide, coupled with a high modulus of elasticity, is particularly responsible for this. The metallic binder used is predominantly cobalt. The sintering operation means that this metallic binder contains not only W and C but also possibly fractions of Cr, if chromium carbide is used as the hard material, for example. In some cases, the metallic binder may also contain Fe and Ni. EP 1 007 751 A1 describes that the use of binders containing Fe, Co and Ni provides a hard metal having improved plasticity, which is attributed to a purely austenitic binder phase after sintering. WO 99/10550 describes tools which are intended for drilling and milling and have an austenitic binder phase, wherein the metallic binder contains 40-90% by weight Co and 4 to 36% by weight of each of Ni and Fe, wherein Fe and Ni are present in the ratio of 1.5:1 to 1:1.5.

It is known that the phase composition can be varied very widely by varying the Fe:Co:Ni ratio in the metallic binder phase of hard metals. Whereas the metallic binder phase in a purely Co-bound hard metal is austenitic after sintering and may become hexagonal during loading, WO 99/10550 discloses the advantages of a stable, austenitic lattice state of an FeCoNi binder alloy after sintering. The binder alloy contains between 90 and 60% by weight Co, the remainder up to 100% by weight being Fe and Ni, wherein the Fe:Ni ratio is about 1 +/−0.5. Owing to their stable lattice type, purely austenitic binder phases of this type provide advantages at all temperatures up to melting point. The investigations carried out on the alloy system FeNi in Wittmann's dissertation are particularly conspicuous; in these investigations, the hardness is increased and the sum of the crack lengths is considerably reduced upon transition from the purely austenitic binder phase (FeNi 80/20) to the diphasic region (FeNi 85/15). The sum of the crack lengths of the investigated hard metals having the binder system FeCoNi 70/10/20, which is likewise in the diphasic austenite/martensite region, is also below those of purely cobalt-bound hard metals. The desirable increase in the hardness without a loss of strength, or vice versa, in comparison with austenitic binder phases is therefore possible with austenitic/martensitic binder phases. However, after precise evaluation of Wittmann's dissertation by the inventors and after calculating the K_{1C} values from the details such as hardness, crack lengths and load, it has been found that the presence of martensitic phase proportions is not a necessary condition for a high K_{1C} value; this can be seen, for example, from the course of the properties of FeNi 85/15-bound hard metals and the K_{1C} values thereof as a function of the carbon content and the martensite content determined by radiography. In actual fact, the increase in the K_{1C} value as compared with cobalt-bound hard metals having the same hardness appears to be a property of binder alloys which have a high iron content and a high Ni:Co ratio, and does not appear to be linked primarily to the presence of martensitic phases as a necessary condition. According to the invention, preference is therefore given to Fe contents of 50 to 90% by weight, particularly preferably in the range from 65 to 90% by weight.

### SUMMARY OF THE INVENTION

The object of the present invention is to increase the strength and therefore the load-bearing capacity of milling and drilling tools made from hard metal, as a result of which process reliability is increased. At the same time, the hardness should remain comparable. This object is achieved by means of a milling and drilling tool having an optionally diphasic (austenitic/martensitic) binder phase which satisfies the conditions of Fe 50 to 90% by weight and Co:Ni of less than 1. In order to increase the hot hardness, the metallic binder phase may advantageously contain further alloying additions such as Cr.

It is essential that the functional regions of the tool consist of hard metal. The tool can therefore be steel-shanked, i.e. only the actual tool consists of hard metal and the transition to the machine tool consists of a different material such as, for example, steel. The transition can be effected by means of a joining process such as, for example, shrink-fitting, or else by soldering.

The invention therefore relates to a hard metal tool which rotates about its own longitudinal axis, has an l/d ratio (length to diameter ratio) of 2 to 200 and is intended for the cutting machining of materials, said tool containing an at least diphasic austenitic/martensitic binder phase and a hard material.

In particular, the invention relates to a hard metal tool which rotates about its own longitudinal axis, has an l/d ratio (length to diameter ratio) of 2 to 200 and is intended for the cutting machining of materials, said tool containing a binder phase and a hard material, wherein the binder phase consists of a hard metal binder phase having the main binder constituents of iron, nickel and cobalt, and the iron content is between 50 and 90% by weight, the nickel content is between 10 and 30% by weight and the cobalt content is at most 30% by weight. The cobalt content is therefore from 0 to 30% by weight or from 5 to 30% by weight.

The following binder constituent contents are advantageous: Fe 70% by weight to 90% by weight, in particular 75% by weight to 85% by weight or 70% by weight to 80% by weight, Ni 10% by weight to 20% by weight, in particular 15% by weight to 20% by weight or 18% by weight to 20% by weight, and optionally cobalt contents of 4 to 15% by weight or of 5 to 12% by weight.

The Co:Ni ratio is preferably less than or equal to 1, particularly preferably from 0.5 to zero, the ratio relating to the amount of these metals in the binder, stated in percent by weight (% by weight).

The following binder compositions are particularly advantageous:

Fe 70% by weight to 90% by weight, Co 0% by weight to 30% by weight, Ni 10% by weight to 20% by weight; or

Fe 75% by weight to 85% by weight, Ni 15% by weight to 20% by weight; or

Fe 75% by weight to 85% by weight, Co 4% by weight to 15% by weight, Ni 15% by weight to 20% by weight; or

Fe 70% by weight to 80% by weight, Co 5% by weight to 12% by weight, Ni 18% by weight to 20% by weight.

These binder compositions are especially advantageous if the Co:Ni ratio is less than or equal to 1 or from 0 to 0.5.

Examples of particularly preferred individual binder compositions are FeNi 85/15, 82/18 and 80/20, FeCoNi 70/12/18, FeCoNi 80/5/15, 70/10/20, 65/20/15 and 75/5/20.

The binder constituent contents are given in percent by weight, based on the composition of the binder. The cobalt to nickel ratio stated above of less than or equal to 1 or less than 0.5 relates to the amounts of these metals in percent by weight.

In this embodiment of the invention, the binder does not contain any constituents other than those listed above, apart from unavoidable impurities.

In a further embodiment of the invention, the binder may also contain the elements C, N, Cr, V, W, Mo, Ta, Nb, Hf, Ti, Zr, Mn, Ru, Re, Al, Ce and La both individually or else in combinations thereof. The presence of these elements may result from using the corresponding nitrides, carbides or carbonitrides or from using element powders. These elements may be present in an overall amount of up to 10% by weight, based on the entire binder phase. The addition of these elements may also be suitable for effecting the polyphasicity of the Fe—Co—Ni binder or even the monophasicity thereof. These elements may advantageously be present in the binder in amounts of from 0.05 to 10% by weight, in particular of from 0.1 to 5% by weight. In this embodiment of the invention, the binder does not contain any further constituents, apart from unavoidable impurities.

Further constituents of the binder used may also be unavoidable impurities, for example oxygen, nitrogen, copper and manganese. Some or all of these may be present in the binder phase after sintering.

The hard metal, of which the tool according to the invention consists, has a binder content of between 3 and 50% by weight, particularly preferably between 5 and 25% by weight.

According to the invention, the binder phase is optionally diphasic after sintering. This means that the binder phase is either diphasic or polyphasic directly after sintering or else that it becomes diphasic or polyphasic during use.

The monophasicity, diphasicity or polyphasicity of the binder may also be achieved by means of an additional heat treatment, i.e. for example an additional heat treatment step in which the tool is annealed, for example. Heat treatment, cooling and tempering operations of this type are familiar to a person skilled in the art from metallurgy and from the process technology of iron-base alloys. However, the heat treatment may also inevitably be effected by a different process step in which the tool is either heated or exothermicity inevitably occurs as a result of, for example, frictional heat, or during soldering.

In addition, the tool optionally contains a hard material which contains one or more strength-increasing and finely distributed third phases from the group consisting of the oxides, nitrides, carbides or intermetallic phases. Suitable hard materials are known to a person skilled in the art; the following are listed here only by way of example: tungsten carbide, vanadium carbide, chromium carbide, titanium carbide, tantalum carbide, niobium carbide or titanium nitride or the mixed phases thereof with one another.

The tool may also be provided with one or more coatings such as, for example, diamond, aluminum oxide, titanium nitride or titanium aluminum nitride. These coatings may have been applied either by CVD or PVD processes or else by a combination thereof, if appropriate also in alternating fashion.

The tool may also have different binder phase proportions along the longitudinal axis and/or different phase compositions in the radial direction, transversely with respect to the longitudinal axis of the tool, and/or different volumetric proportions of binder along the longitudinal and/or transverse axis.

The tool may optionally have hollow spaces along the axis in order to supply coolant to the cutting edge for the machining.

In particular, the tool according to the invention can be used for machining composite materials, printed circuit boards, iron-based or non-iron-based metallic materials, wood materials, stone materials (such as, for example, stone building materials and earths) or combinations thereof. The machining may be effected by drilling and/or milling. Therefore, the invention also relates to the use of a tool according to the invention for the machining of materials by drilling or milling.

In addition, the invention therefore also relates to a device for machining materials (in particular the materials stated above), wherein the device comprises a tool according to the invention.

### EXAMPLES

1. A hard metal powder mixture consisting of 90% by weight WC powder having a grain size of 0.8 μm FSSS (ASTM B330) and a binder metal content of 10% by weight consisting of prealloyed 70Fe12Co18Ni powder (amounts of the alloying elements in % by weight) was produced in an attritor by means of wet grinding and processed in a conventional spray dryer to form granules. Before spray drying, an emulsion of paraffin wax was added with constant stirring to the suspension obtained from the wet grinding after removal of the grinding balls, such that the wax content of the spray-dried granules was 2% by weight. The carbon content of the mixture was set by adding carbon black in such a way that, after sintering, the hard metal does not contain any harmful third phases such as free carbon or carbon deficit carbides (“eta phases”). Round hard metal rods were produced both by extrusion (for this purpose, kneading was carried out beforehand using an organic plasticizer) and by axial dry pressing and were then sintered in vacuo in a graphite sintering furnace at 1450° C. for one hour after expulsion of the organic plasticizing constituents or the wax. The metallographic investigation of the semi-finished hard metal products showed that the hard metal was characterized by a uniform microstructure having a WC grain size of about 0.8 micrometer. The binder distribution was good and very few coarse WC grains having a size of up to 3 μm or above could be seen. The hardness of the hard metal was 1720HV10 and the investigation by radiography showed that the binder consists of martensite and austenite. The hard metal blanks were ground to form three-edged milling tools having a length of D=10 mm (dimensions similar to DIN 6527) for processing metals and then provided with a TiAlN-based PVD coating customary in industry. Tests on the tool life were carried out during profile milling at a cutting speed of 250 m/min on a low-alloy steel of the 42CrMo4 type. The tool life of a conventional, comparable WC-Co hard metal was 70 parts; a tool life of 100 parts was achieved with the WC-FeCoNi hard metal under the same machining conditions.

2. A hard metal powder mixture consisting of 92% by weight WC having a grain size of 0.6 μm FSSS and a binder content of 8% by weight consisting of prealloyed 85Fe15Ni was produced as in example 1) and, after kneading with a suitable plastic binder, was shaped in a ram extruder to form hard metal blanks having a diameter of 3.25 mm after sintering. The hardness of the hard metals sintered by the HIP process was 1900HV10. The microstructure was very uniform and had no coarse WC grains >2 μm. The blanks were processed to form hard metal milling cutters having a diameter of 1.5 mm. These tools were used to machine printed circuit boards for the electronics industry under industrially conventional operating conditions (this refers to the base material, drilling conditions, drilling bases, CNC machine, suction-extraction systems and the test parameters of feed and rotational speed). The comparative milling cutters consisting of WC-Co had a tool life of 10.1 m and the milling cutter with the

FeNi binder had a tool life of 13.5 mm in the rupture behavior test. The WC-85Fe15Ni hard metals were also tested as drills having a diameter <0.3 mm for printed circuit boards. The average wear of the standard drills was 11 units, and only 8.5 units for the WC-FeNi drill.

As regards the service life of the drills, the standard drill reached a service life of 3500 drill holes, whereas the WC-FeNi drill reached a service life of 4500 drill holes. The conventional WC-Co drills showed an increased risk of the main cutting edges fracturing as compared with the WC-FeNi drills.

1.-15. (canceled)

16. A hard metal tool which rotates about its own longitudinal axis, has an lid ratio of
2 to 200 and is intended for the drilling or milling of materials, wherein the hard metal tool consists of a hard material phase and a binder phase, wherein the main binder constituents are iron, nickel and cobalt, the iron content is between 50 and 90% by weight, the nickel content is between 10 and 30% by weight, the cobalt content is at most 30% by weight and the cobalt to nickel Co:Ni ratio is less than or equal to 1, based on by weight.

17. The tool as claimed in claim 16, wherein the binder content of the hard metal is between 3 and 50% by weight.

18. The tool as claimed in claim 17, wherein the binder phase is diphasic or polyphasic after sintering, or becomes diphasic or polyphasic during use.

19. The tool as claimed in claim 18, wherein the diphasicity or polyphasicity of the binder is achieved by means of a heat treatment.

20. The tool as claimed in claim 18, wherein the polyphasicity of the binder is
influenced by individual elements selected from the group consisting of C, N, Cr, V, Ta, Mo, W, Nb, Hf, Ti, Zr, Mn, Ru, Re, Al, Ce and La or combinations thereof in a total of up to 10% by weight, based on the entire binder phase.

21. The tool as claimed in claim 16, wherein the polyphasic Fe—Co—Ni binder contains one or more strength-increasing and finely distributed third phases from the group consisting of the oxides, nitrides, carbides or intermetallic phases.

22. The tool as claimed in claim 16, wherein the tool is provided with one or more coatings.

23. The tool as claimed in claim 16, wherein the tool has different binder phase proportions along the longitudinal axis.

24. The tool as claimed in claim 16, wherein the tool has a different phase composition in the radial direction, transversely with respect to the longitudinal axis of the tool.

25. The tool as claimed in claim 16, wherein the tool has different volumetric proportions of binder along the longitudinal and/or transverse axis.

26. The tool as claimed in claim 16, wherein only the functional regions of the tool consist of hard metal.

27. The tool as claimed in claim 16, wherein hollow spaces are present along the axis in order to supply coolant to the cutting edge for the machining.

28. A process for drilling or milling a material which comprises drilling or milling a material with the tool as claimed in claim 16.

29. The process as claimed in claim 28, wherein the material is a composite material, a printed circuit board, an iron-based or a non-iron-based metallic material, a wood material, a stone material.

30. A device for machining materials, wherein the device comprises the tool as claimed in claim 16.
